(19) United States
(12) Patent Application Publication
(10) Pub. No.: US 2021/0087368 A1
(43) Pub. Date: Mar. 25, 2021

(54) ANTIVIBRATION RUBBER COMPOSITION, AND ANTIVIBRATION RUBBER

(71) Applicant: BRIDGESTONE CORPORATION, Tokyo (JP)

(72) Inventors: Nahoko ITO, Chuo-ku, Tokyo (JP); Yasuo HORIKAWA, Chuo-ku, Tokyo (JP); Kei KIMURA, Chuo-ku, Tokyo (JP); Kazutaka OTSU, Chuo-ku, Tokyo (JP)

(73) Assignee: BRIDGESTONE CORPORATION, Tokyo (JP)

(21) Appl. No.: 16/772,010

(22) PCT Filed: Dec. 11, 2018
(86) PCT No.: PCT/JP2018/045532

§ 371 Date: Jun. 11, 2020

(30) Foreign Application Priority Data
Dec. 13, 2017 (JP) 2017-238982

(51) Int. Cl. C08L 9/06; F16F 15/08

(52) U.S. Cl. CPC C08L 9/06; C08K 3/04; F16F 15/08

(57) ABSTRACT

The antivibration rubber composition of the present invention contains a styrene-butadiene rubber (A) having a polystyrene-equivalent weight-average molecular weight of 700,000 or more, and a liquid styrene-butadiene rubber (B) having a polystyrene-equivalent weight-average molecular weight of 12,000 or less, wherein the total amount of the vinyl bond content in the rubber (A) and the vinyl bond content in the liquid rubber (B) relative to the total amount of the rubber (A) and the liquid rubber (B) is 25% by mass or more. The antivibration rubber using the composition exhibits ultra-low spring property and high durability.

### TECHNICAL FIELD

The present invention relates to an antivibration rubber composition and an antivibration rubber.

### BACKGROUND ART

For example, heretofore, an antivibration rubber has been used in various vehicles including automobiles for purposes of preventing noise by absorbing vibration occurring in driving an engine. Recently, an antivibration rubber used for such purposes is interposed as members to constitute a vibration transmission or shock transmission system and is required to be able to satisfy both physical properties excellent in antivibration performance and sufficient durability and to be able to control spring characteristics in a broad range so as to be applicable to wide range running scenes.

For making an antivibration rubber have a low spring action, heretofore employed is a method of adding a softener such as oil, or a method of reducing the amount of a filler such as carbon or silica, or a combination thereof.

On the other hand, generally known is a method of reinforcing an antivibration rubber with a filler for improving the durability thereof. By adding a filler up to a predetermined amount, the reinforcing degree increases and the durability also increases.

Accordingly, when durability increases, then the value of a low spring action (hereinafter this may be referred to as “static spring constant) increases as coupled with that, and on the contrary, when a low spring action is realized to be a predetermined value, then durability lowers also coupled with that, and in that manner, there is a paradoxical problem between low spring action and durability. This point will be described in detail later.

Consequently, for an antivibration rubber, realizing both low spring action and durability is a major challenge.

For example, PTL 1 discloses, for satisfying both low dynamic spring characteristics (also referred to as “low dynamic magnification”) and high attenuation characteristics while maintaining durability, an antivibration rubber produced by vulcanization-molding a composition prepared by mixing an unvulcanized dienic rubber material consisting mainly of vinyl and styrene with a liquid styrene-butadiene rubber, in which, in a matrix of the vulcanization-molded dienic rubber material, the other rubber component than the liquid component of the liquid styrene-butadiene rubber is vulcanized and dispersed as an island phase to form a sea-island structure therein, and in which the liquid styrene-butadiene rubber is one having a glass transition temperature of −35 to −10° C.

On the other hand, for example, PTL 2 discloses, for satisfying both low dynamic spring characteristics and high attenuation characteristics while maintaining durablity, an antivibration rubber produced by vulcanization-molding a composition prepared by mixing an unvulcanized dienic rubber material consisting mainly of vinyl and styrene with a liquid styrene-butadiene rubber and adding thereto, as a reinforcing agent, 45 to 85 parts by weight of a high-structure-type carbon black of an MAF and/or FEF class, in which, in a matrix of the vulcanization-molded dienic rubber material, the other rubber component than the liquid component of the liquid styrene-butadiene rubber is vulcanized and dispersed as an island phase to form a sea-island structure therein.

Further, for example, PTL 3 discloses, for satisfying both low dynamic magnification and high durability, an antivibration rubber composition containing a dienic rubber and, as a filler, carbon black and silica, in which the mixing ratio of carbon black (a) to silica (b) is (a)/(b)=80/20 to 20/80 (by mass).

Also, for example, PTL 4 discloses, for providing a high-attenuation composition capable of forming a high-attenuation member excellent in attenuation performance and having properties such as stiffness stable in a broad temperature range with little temperature dependence, and additionally excellent in processability, a high-attenuation composition prepared by mixing at least one liquid homopolymer selected from the group consisting of a liquid isoprene rubber and a liquid butadiene rubber, and at least one filler selected from the group consisting of silica and carbon black in a base polymer of a dienic rubber wherein the mixing ratio of the liquid homopolymer is 31 parts by mass or more relative to 100 parts by mass of the dienic rubber.

### CITATION LIST

### Patent Literature

PTL 1: JP 2005-114141 A

PTL 2: JP 2005-113094 A

PTL 3: JP 2011-105870 A

PTL 4: JP 2013-67767 A

### SUMMARY OF INVENTION

### Technical Problem

An antivibration rubber is required have an ability to control spring characteristics in a broad range so as to satisfy both physical properties excellent in antivibration performance and sufficient durability and so as to be applicable to a wide-range running scenes.

The present invention is to provide an antivibration rubber composition capable of satisfying both ultra-low spring property and durability when vulcanized to a vulcanized rubber, and an antivibration rubber.

### Solution to Problem

As a result of assiduous studies, the present inventors have found that when large amounts of an oil and a resin are mixed for lowering a static spring constant, durability (for example, crack resistance) of rubber greatly lowers. Accordingly, the inventors have known that, by mixing an liquid rubber but not an oil so as to increase entangling of molecular chains and to increase energy scattering, a low static spring constant can be maintained and durability can also be satisfied. In addition, the inventors have further found that, in an ultra-low spring region, a styrene-butadiene rubber (hereinafter also referred to as “SBR rubber”) can rather exhibit higher crack resistance than natural rubber. On the basis of these findings, the inventors have completed the present invention.

Specifically, the present invention provides:

[1] An antivibration rubber composition containing a styrene-butadiene rubber (A) having a polystyrene-equivalent weight-average molecular weight of 700,000 or more, and a liquid styrene-butadiene rubber (B) having a polystyrene-equivalent weight-average molecular weight of 12,000 or less, wherein:

the total amount of the vinyl bond content in the styrene-butadiene rubber (A) and the vinyl bond content in the liquid styrene-butadiene rubber (B) relative to the total amount of the styrene-butadiene rubber (A) and the liquid styrene-butadiene rubber (B) is 25% by mass or more, and

[2] An antivibration rubber produced by vulcanizing the antivibration rubber composition of [1].

### Advantageous Effects of Invention

According to the present invention, there can be provided an antivibration rubber composition capable of satisfying both ultra-low spring property and durability when vulcanized to a vulcanized rubber, and an antivibration rubber produced by vulcanizing the antivibration rubber composition.

### DESCRIPTION OF EMBODIMENTS

### <Antivibration Rubber Composition>

Hereinunder the antivibration rubber composition of an embodiment of the present invention is described in detail.

The antivibration rubber composition of the present invention contains a styrene-butadiene rubber (A) having a polystyrene-equivalent weight-average molecular weight of 700,000 or more, and a liquid styrene-butadiene rubber (B) having a polystyrene-equivalent weight-average molecular weight of 12,000 or less, and optionally contains a filler, wherein the vinyl content is 25% or more relative to the total amount of the styrene-butadiene rubber (A) and the liquid styrene-butadiene rubber (B).

It is presumed that, in the antivibration rubber composition of the present invention, even when the amount of a filler to be added is reduced as with that in already-existing antivibration rubbers, entangling of molecular chains increases and therefore energy scattering can be enhanced since a specific high-molecular-weight styrene-butadiene rubber (A) and a specific low-molecular-weight styrene-butadiene rubber (B) are combined therein, and consequently, the antivibration rubber composition of the present invention can satisfy durability while maintaining an ultra-low spring property.

In particular, in the antivibration rubber produced by vulcanizing the antivibration rubber composition, when the amount of the filler is reduced as compared with that in already-existing antivibration rubbers and a large amount of a softener (for example, oil) is added thereto for securing ultra-low spring property, the durability of the antivibration rubber worsens.

On the other hand, it is presumed that, in the present invention, for securing ultra-low spring property, the amount of the filler to be added is reduced as compared with that in already-existing antivibration rubbers and instead, owing to “entangling” due to a combination of the specific high-molecular-weight styrene-butadiene rubber (A) and the specific low-molecular-weight styrene-butadiene rubber (B) therein, the stress to be applied to the rubber can be dispersed and, further, the energy to be applied to the rubber can be scattered by the specific low-molecular-weight styrene-butadiene rubber (B), and accordingly, the antivibration rubber produced by vulcanizing the resultant antivibration rubber composition can satisfy both ultra-low spring property and durability.

### [Styrene-Butadiene Rubber (A)]

The polystyrene-equivalent weight-average molecular weight (Mw) of the styrene-butadiene rubber (A) that forms a matrix in the resultant antivibration rubber is 700,000 or more, preferably 800,000 or more, more preferably 850,000 or more. When the polystyrene-equivalent weight-average molecular weight (Mw) of the styrene-butadiene rubber (A) is 700,000 or more, “entangling” with the styrene-butadiene rubber (B) having a specific molecular weight to be mentioned forms to thereby enhance the durability, for example, crack forming resistance of the antivibration rubber formed after vulcanization of the antivibration rubber composition. The polystyrene-equivalent weight-average molecular weight (Mw) of the styrene-butadiene rubber (A) is preferably 1,500,000 or less.

In this description, the weight-average molecular weight (Mw) and the number-average molecular weight (Mn) of the copolymer (including the styrene-butadiene rubber (A) and the styrene-butadiene rubber (B)) each mean a polystyrene-equivalent weight-average molecular weight determined through gel permeation chromatography (GPC).

The styrene-butadiene rubber (A) may be prepared through solution polymerization or may be prepared through emulsion polymerization.

“Styrene/vinyl” (St/Vi) in the styrene-butadiene rubber (A) is preferably (20 to 50)/(15 to 50), more preferably (24 to 46)/(16 to 46).

The glass transition temperature (Tg) of the styrene-butadiene rubber (A) is preferably −60 to −20° C., more preferably −55 to −20° C., and is preferably lower than the glass transition temperature (Tg) of the styrene-butadiene rubber (B) to be mentioned below.

In this description, in “styrene/vinyl” or “St/Vi”, “styrene (St)” means a styrene mixing ratio by mass in the intended styrene-butadiene rubber, and “vinyl (Vi)” means a vinyl bond content in the intended styrene-butadiene rubber. Strictly, this is “styrene (mass %)/vinyl (mass %)” or “St (mass %)/Vi (mass %)”, and the same shall apply hereinunder, that is, the description in the Tables below is in accordance with the above-mentioned definition.

### [Liquid Styrene-Butadiene Rubber (B)]

In the antivibration rubber formed herein, the polystyrene-equivalent weight-average molecular weight (Mw) of the liquid styrene-butadiene rubber (B) to be dispersed in the matrix phase is 12,000 or less, preferably 11,000 or less, more preferably 10,000 or less. When the polystyrene-equivalent weight-average molecular weight (Mw) of the styrene-butadiene rubber (B) is 12,000 or less, “entangling” with the above-mentioned styrene-butadiene rubber (A) having a specific high molecular weight occurs to improve the durability, for example, the crack growth resistance of the antivibration rubber to be formed by vulcanizing the antivibration rubber composition. The polystyrene-equivalent weight-average molecular weight (Mw) of the liquid styrene-butadiene rubber (B) is preferably 5,000 or more.

Also the polystyrene-equivalent number-average molecular weight (Mn) of the styrene-butadiene rubber (B) is preferably 5,000 or less, more preferably 4,500 or less. The polystyrene-equivalent number-average molecular weight (Mn) of the liquid styrene-butadiene rubber (B) is preferably 1,000 or more.

The liquid styrene-butadiene rubber (B) may be prepared through solution polymerization or may be prepared through emulsion polymerization.

“Styrene/vinyl” (St/Vi) in the liquid styrene-butadiene rubber (B) is preferably (20 to 30)/(20 to 75), more preferably (25 to 30)/(50 to 70).

The glass transition temperature (Tg) of the styrene-butadiene rubber (B) is preferably −70 to −10° C., more preferably −30 to −15° C., and is preferably higher than the glass transition temperature (Tg) of the styrene-butadiene rubber (A) mentioned hereinabove.

For forming suitable “entangling” between the styrene-butadiene rubbers (A) and (B) for attaining desired durability, the total amount of the vinyl bond content in the styrene-butadiene rubber (A) and the vinyl bond content in the liquid styrene-butadiene rubber (B) relative to the total amount of the styrene-butadiene rubber (A) and the liquid styrene-butadiene rubber (B) is 25% by mass or more, preferably 27% by mass or more, even more preferably 30% by mass or more.

For satisfying both ultra-low spring property and durability, the mixing amount of the liquid styrene-butadiene rubber (B) is preferably 10 parts by mass or more relative to 100 parts by mass of the rubber component, more preferably 15 parts by mass or more, even more preferably 20 parts by mass or more, and especially more preferably 25 parts by mass or more. The mixing amount of the liquid styrene-butadiene rubber (B) is also preferably 70 parts by mass or less, more preferably 60 parts by mass or less, even more preferably 50 parts by mass or less, still more preferably 45 parts by mass or less, and especially more preferably 40 parts by mass or less.

Further, the antivibration rubber composition of the present invention may contain any other dienic rubber than the styrene-butadiene rubbers (A) and (B).

As the dienic rubber, a known one can be used without particular limitations, and examples thereof include a natural rubber (NR); a dienic synthetic rubber such as a butadiene rubber (BR), an isoprene rubber, a styrene-isoprene copolymer, a chloroprene rubber, an acrylonitrile-butadiene rubber, and an acrylate butadiene rubber; and a natural rubber or a dienic synthetic rubber having a modified molecular chain terminal such as an epoxidized natural rubber.

The antivibration rubber composition of the present invention may contain a single or two or more kinds of the dienic rubber described above.

Preferably, the antivibration rubber composition of the present invention contains, among the dienic rubbers, at least one selected from the group consisting of a natural rubber, a butadiene rubber, and a styrene-butadiene rubber, and more preferably at least a natural rubber. For example, the antivibration rubber composition of the present invention may contain a natural rubber alone or a natural rubber and a butadiene rubber as the dienic rubber.

The antivibration rubber composition of the present invention may contain a rubber (any other rubber) than a dienic rubber, but from the viewpoint of not detracting from the advantageous effects of the present invention, the content of the styrene-butadiene rubbers (A) and (B) and the dienic rubber among all the rubbers of the styrene-butadiene rubbers (A) and (B), the dienic rubber and the other rubber is preferably 80% by mass or more of the total mass of the rubbers, more preferably 90% by mass or more, even more preferably 95% by mass or more, and is especially more preferably 100% by mass.

Examples of the other rubber include an acrylic rubber, an ethylene-propylene rubber (EPR, EPDM), a fluorine rubber, a silicone rubber, a urethane rubber, and a butyl rubber, and these may be used singly or in combinations of two or more.

From the viewpoint of not detracting from the advantageous effects of the present invention, the content of the other rubber in all the rubbers is preferably 20 mass % or less, more preferably 10 mass % or less, still more preferably 5 mass % or less, particularly preferably 0 mass %, relative to the total mass of the rubbers.

### [Filler]

Further, the antivibration rubber composition and the antivibration rubber produced by vulcanizing the composition of the present invention may contain a filler. For enhancing low spring property, the filler is preferably carbon black having a nitrogen adsorption specific surface area, as measured according to JIS K 6217-2:2001, of 90 to 150 m²/g, more preferably carbon black with 110 to 150 m²/g, even more preferably carbon black with 130 to 150 m²/g.

As the carbon black, in particular, ISAF and SAF are preferred. One alone or two or more kinds of these carbon blacks may be used either singly or as combined.

The amount of the filler to be added is, for the purpose of improving low spring property, preferably 40 parts by mass or less relative to 100 parts by mass of the total amount of matrix rubber except the liquid styrene-butadiene rubber (B), more preferably 1 to 40 parts by mass, even more preferably 1 to 20 parts by mass, and especially more preferably 1 to 10 parts by mass. Here, for example, in the case where the rubber component is a natural rubber and the styrene-butadiene rubber (A), the amount of the filler is meant to fall within the above-mentioned range relative to 100 parts by mass of the total amount of natural rubber and the styrene-butadiene rubber (A).

The antivibration rubber composition of the present invention may contain, together with the above-mentioned components, agents mixed for use in a common antivibration rubber composition. Examples include usually mixed various compounding ingredients such as various fillers excluding carbon black and silica (e.g., clay and calcium carbonate), sulfur as a vulcanizing agent, a vulcanization accelerator, a vulcanization accelerator aid, a softener such as various process oils, zinc oxide, stearic acid, wax, and an antiaging agent.

Sulfur can be used as a vulcanizing agent. The amount of sulfur to be mixed is generally 0.1 to 5 parts by mass relative to 100 parts by mass of the rubber component.

Examples of the vulcanization accelerator for accelerating vulcanization include benzothiazole-based vulcanization accelerators such as 2-mercaptobenzothiazole, dibenzothiazyl disulfide, N-cyclohexyl-2-benzothiazyl sulfenamide, N-t-butyl-2-benzothiazyl sulfenamide, and N-t-butyl-2-benzothiazyl sulfenamide; guanidine-based vulcanization accelerators such as diphenylguanidine; thiuram-based vulcanization accelerators such as tetramethylthiuram disulfide, tetrabutylthiuram disulfide, tetradodecylthiuram disulfide, tetraoctylthiuram disulfide, and tetrabenzylthiuram disulfide; dithiocarbamate-based vulcanization accelerators such as zinc dimethyldithiocarbamate; and other zinc dialkyldithiophosphates.

As the vulcanization accelerator, one alone or two or more kinds of sulfenamide-based, thiuram-based, thiazole-based, guanidine-based and dithiocarbamate-based vulcanization accelerators can be used either singly or as combined. For controlling vulcanization behavior (speed), a combination of a thiuram-based and/or thiazole-based vulcanization accelerator having a relatively high vulcanization acceleration performance, and a guanidine-based and/or sulfenamide-based vulcanization accelerator having a relatively moderate to low vulcanization acceleration performance is preferred. Specifically, examples include a combination of tetramethylthiuram disulfide and N-cyclohexyl-2-benzothiazyl sulfenamide, a combination of tetrabutylthiuram disulfide and N-t-butyl-2-benzothiazyl sulfenamide, and a combination of dibenzothiazyl disulfide and diphenylguanidine. The amount of the vulcanization accelerator to be mixed is preferably 0.2 to 10 parts by mass relative to 100 parts by mass of the rubber component.

The present invention includes not only a case of an extension oil for the rubber component (for example, the styrene-butadiene rubber (A)) but also a case of a combination of the liquid styrene-butadiene rubber (B) and an oil. Oil is an optional component here. Any known oils can be used with no specific limitation, and specifically, process oils such as an aromatic oil, a naphthenic oil and a paraffin oil, vegetable oils such as a coconut oil, synthetic oils such as an alkylbenzene oil, and a castor oil can be used. These can be used singly or in combination of two or more.

In the present invention, from the viewpoint of accelerating vulcanization, a vulcanization accelerator aid such as zinc oxide (ZnO) and fatty acids can be mixed.

Fatty acids may be any of saturated or unsaturated, linear or branched fatty acids, and the carbon number of the fatty acid is not also specifically limited. For example, fatty acids having 1 to 30 carbon atoms, preferably 15 to 30 carbon atoms can be used, and more concretely, examples thereof include naphthenic acids such as cyclohexanoic acid (cyclohexane-carboxylic acid), and alkylcyclopentanes having a side chain; saturated fatty acids such as hexanoic acid, octanoic acid, decanoic acid (including branched carboxylic acid such as neodecanoic acid), dodecanoic acid, tetradecanoic acid, hexadecanoic acid, and octadecanoic acid (stearic acid); unsaturated fatty acids such as methacrylic acid, oleic acid, linoleic acid, and linolenic acid, and resin acids such as rosin, tall oil acid, and abietic acid. The vulcanization accelerator aids may be used singly or in combinations of two or more. In the present invention, zinc oxide and stearic acid can be suitably used.

The amount of the vulcanization accelerator aid mixed is preferably 1 to 15 parts by mass, more preferably 2 to 10 parts by mass, relative to 100 parts by mass of all the rubbers.

The antiaging agent is not especially limited and any known agents can be used, and examples include phenol-based antiaging agents, imidazole-based antiaging agents, and amine-based antiaging agents. The amount of the antiaging agent mixed is typically 0.5 to 10 parts by mass, preferably 1 to 5 parts by mass, relative to 100 parts by mass of all the rubbers.

In producing the antivibration rubber composition of the present invention, a method for mixing the aforementioned components is not especially limited, and all the components as raw materials may be mixed at one time and kneaded, or the individual components may be mixed in any of two or three steps and then kneaded. Moreover, in kneading the components, any of kneaders such as a roll, an internal mixer and a Banbury rotor can be used. Besides, if the resultant substance is to be molded into a shape of a sheet or a belt, any of known molding machines such as an extruder and a press may be used.

### <Antivibration Rubber>

The antivibration rubber of the present invention is produced by vulcanizing the antivibration rubber composition of the present invention having the above-described structure.

Vulcanizing conditions employed in vulcanizing the antivibration rubber composition are not especially limited, and conditions of 140 to 180° C. and 5 to 120 minutes can be typically employed.

The antivibration member of the present invention is generally a structural member produced by bringing a rubber material into contact with another member such as metal or resin, and an unvulcanized rubber composition and the above-mentioned another member are pressed under heat optionally using an adhesive agent, whereby the rubber composition is vulcanized and at the same time the vulcanized rubber and the another are bonded and integrated to give an antivibration member. The antivibration member may have any of various adhesive agents between vulcanized rubber and metal, or between vulcanized rubber and resin, or may be directly integrated by engagement not using an adhesive agent.

### EXAMPLES

Hereinunder the present invention is described in more detail with reference to Examples. The present invention is not limited by Examples. In the following description, unless otherwise specifically indicated, “%” and “part” are all “% by mass” and “part by mass”, respectively. In Tables, the amount added is “part by mass”. For various measurement and evaluation, the following methods are employed.

### Examples 1 to 3, Comparative Examples 1 to 6

The components for giving mixing formulations shown in the following Table 1 and Table 2 were kneaded to give antivibration rubber compositions of Examples 1 to 3 and Comparative Examples 3 to 6, and the resultant antivibration rubber compositions were cured by vulcanization to give antivibration rubbers. In Comparative Examples 1 and 2, an antivibration rubber composition is produced and an antivibration rubber is produced.

In Comparative Examples 4 and 5, “#0202” from JSR Corporation was used as a styrene-butadiene rubber (A).

In Examples 1 to 3 and Comparative Example 4, “Ricon (registered trademark) 100” from CRAY VALLEY Corporation was used as a liquid styrene-butadiene rubber (B); and in Comparative Example 2, “Ricon (registered trademark) 181” from CRAY VALLEY Corporation was used as a liquid styrene-butadiene rubber (B).

In Examples 1 to 3 and Comparative Examples 1 to 3, an emulsion-polymerized SBR from JSR Corporation was used as a styrene-butadiene rubber (A).

From the vulcanization condition of each antivibration rubber composition of Examples 1 to 3 and Comparative Examples 3 to 6, the vulcanization properties thereof were evaluated. As an index of durability of the resultant antivibration rubber, an extension fatigue durability was measured and evaluated; and as an index of low spring property, a static spring constant (Ks) was measured and evaluated. In Examples 1 and 2, prediction evaluation was made. The results are shown in Table 1 and Table 2.

### <Extension Fatigue Durability>

From the sample obtained in each Example and Comparative Example of Examples 1 to 3, and Comparative Examples 3 to 6, a dumbbell-shaped test piece was prepared, and given repeated fatigue with a constant strain of 100 to 300% at 35° C., and the frequency of fatigue repetition was counted until the test piece was broken. From the inputted energy given to the test piece in each strain test and the frequency of breakage in each strain test, an energy-breakage frequency conversion expression was calculated. In Comparative Examples 1 and 2, the samples were tested and the data were calculated. In the conversion expression, the breakage frequency conversion value at the time when the inputted energy is 1 MPa is referred to as crack growth resistance, and the samples of Examples and Comparative Examples were tested to determine the crack growth resistance. The breakage frequency conversion value in Comparative Example 3 is standardized to be an index 100. Samples having a larger index are more excellent in durability.

### <Static Spring Constant (Ks)>

A sample of the rubber composition of Examples 1 to 3 and Comparative Examples 3 to 6 was press-molded (with vulcanization) to form a cylindrical test piece (diameter 8 mm, height 6 mm), and using a dynamic viscoelasticity tester (trade name “Eplexor 500N”, from GABO Corporation), the test piece was tested at a test temperature of 35° C. according to the following method to evaluate the spring properties thereof. In Comparative Examples 1 and 2, the samples were tested and evaluated.

Each test piece was 20% compressed in the axial direction under a load given thereto in the axial direction, then once unloaded, and again 20% compressed in the axial direction. In the process, the load-deflection characteristic in the 2nd loading step was measured, and based on this, the load-deflection curve of the sample was drawn. On the curve, the load value: P5% and P15% (unit is N) at a deflection of 5% and 15%, respectively, was read, and a static spring constant: Ks (N/mm) was calculated according to the expression: Ks=(P15%−P5%)/0.6 mm (length of 15%−5%).

The static spring constant in Comparative Example 6 is standardized to be an index 100. Samples having a smaller index are more excellent in low spring property.

TABLE 1

| | | Example | | |
|---|---|---|---|---|
| | | 1 | 2 | 3 |
| Formulation | Natural Rubber*1 | 20 | 20 | 20 |
| Ingredients | Styrene-Butadiene | 80 | 80 | 80 |
| (part by mass) | Rubber (A) | | | |
| | Mw | 890,000 | 900,000 | 890,000 |
| | Mn | 270,000 | 260,000 | 270,000 |
| | St/Vi | 46/16 | 40/16 | 46/16 |
| | Ratio by mass of | 46/54 | 40/60 | 46/54 |
| | styrene/butadiene | | | |
| | Vinyl bond amount | 16 | 16 | 16 |
| | (mass %) in SBR (A) | | | |
| | Tg (° C.) | −22 | −35 | −22 |
| | Polymerization Method | emulsion | emulsion | emulsion |
| | | polymerization | polymerization | polymerization |
| | Liquid Styrene-Butadiene | 30 | 30 | 15 |
| | Rubber (B) | | | |
| | Mw | 10,000 | 10,000 | 10,000 |
| | Mn | 4,500 | 4,500 | 4,500 |
| | St/Vi | 25/70 | 25/70 | 25/70 |
| | Ratio by mass of | 25/75 | 25/75 | 25/75 |
| | styrene/butadiene | | | |
| | Vinyl bond amount | 70 | 70 | 70 |
| | (mass %) in liquid SBR | | | |
| | Tg (° C.) | −15 | −15 | −15 |
| | Carbon Black*2 | 2 | 2 | 2 |
| | Stearic Acid | 2 | 2 | 2 |
| | Zinc Oxide*3 | 1 | 1 | 1 |
| | Antiaging Agent RD*4 | 1 | 1 | 1 |
| | Antiaging Agent 6C*5 | 1 | 1 | 1 |
| | Oil*6 | 27 | 30 | 42 |
| | Sulfur*7 | 0.5 | 0.5 | 0.5 |
| | Vulcanization Accelerator | 1.1 | 1.1 | 1.1 |
| | CZ*8 | | | |
| | Vulcanization Accelerator | 0.1 | 0.1 | 0.1 |
| | DM*9 | | | |
| {Vinyl bond content (a) in SBR (A) + vinyl bond | | 25 | 25 | 25 |
| content (b) in liquid SBR (B)]/[content of SBR | | | | |
| (A) + content of liquid SBR (B)} (mass %) | | | | |
| Durability | Crack Growth Resistance | 120 | 117 | 115 |
| | (index) | | | |
| | Extension Fatigue Durability | 12000 | 9400 | 8000 |
| Low Spring | Static Spring Constant (Ks) | 8.2 | 9.1 | 8 |
| Property | Static Spring Constant | 13.7 | 15.2 | 13.3 |
| | (index) | | | |

TABLE 2

| | | Comparative Example | | | | | |
|---|---|---|---|---|---|---|---|
| | | 1 | 2 | 3 | 4 | 5 | 6 |
| Formulation | Natural Rubber*1 | 20 | 20 | 20 | 20 | 20 | 100 |
| Ingredients | Styrene-Butadiene | 80 | 80 | 80 | 80 | 80 | 0 |
| (part by mass) | Rubber (A) | | | | | | |
| | Mw | 890,000 | 900,000 | 900,000 | 400,000 | 400,000 | — |
| | Mn | 270,000 | 260,000 | 260,000 | 140,000 | 140,000 | |
| | St/Vi | 46/16 | 40/16 | 40/16 | 46/19 | 46/19 | — |
| | Ratio by mass of | 46/54 | 40/60 | 40/60 | 46/54 | 46/54 | — |
| | styrene/butadiene | | | | | | |
| | Vinyl bond amount | 16 | 16 | 16 | 19 | 19 | — |
| | (mass %) in SBR (A) | | | | | | |
| | Tg (° C.) | −22 | −35 | −35 | −25 | −25 | — |
| | Polymerization Method | emulsion | emulsion | emulsion | emulsion | emulsion | — |
| | | polymerization | polymerization | polymerization | polymerization | polymerization | |
| | Liquid Styrene-Butadiene | — | 30 | — | 36 | — | — |
| | Rubber (B) | | | | | | |
| | Mw | — | 7,000 | — | 10,000 | — | — |
| | Mn | — | 3,200 | — | 4,500 | — | — |
| | St/Vi | — | 25/70 | — | 25/70 | — | — |
| | Ratio by mass of | — | 28/72 | — | 25/75 | — | — |
| | styrene/butadiene | | | | | | |
| | Vinyl bond amount | — | 30 | — | 70 | — | — |
| | (mass %) in liquid SBR | | | | | | |
| | Tg (° C.) | — | −65 | — | −15 | — | — |
| | Carbon Black*2 | 2 | 2 | 2 | 2 | 2 | 35 |
| | Stearic Acid | 2 | 2 | 2 | 2 | 2 | 2 |
| | Zinc Oxide*3 | 1 | 1 | 1 | 1 | 1 | 1 |
| | Antiaging Agent RD*4 | 1 | 1 | 1 | 1 | 1 | 1 |
| | Antiaging Agent 6C*5 | 1 | 1 | 1 | 1 | 1 | 1 |
| | Oil*6 | 63 | 30 | 60 | 27 | 63 | 5 |
| | Sulfur*7 | 0.5 | 0.5 | 0.5 | 0.5 | 0.5 | 0.5 |
| | Vulcanization Accelerator | 1.1 | 1.1 | 1.1 | 1.1 | 1.1 | 1.1 |
| | CZ*8 | | | | | | |
| | Vulcanization Accelerator | 0.1 | 0.1 | 0.1 | 0.1 | 0.1 | 0.1 |
| | DM*9 | | | | | | |
| {Vinyl bond content (a) in SBR (A) + | | — | 13 | — | 26 | — | — |
| vinyl bond content (b) in liquid SBR | | | | | | | |
| (B)]/[content of SBR (A) + content of | | | | | | | |
| liquid SBR (B)} (mass %) | | | | | | | |
| Durability | Crack Growth Resistance | 111 | 104 | 100 | 84 | 76 | 125 |
| | (index) | | | | | | |
| | Extension Fatigue Durability | 5900 | 3500 | 2500 | 700 | 390 | 50000 |
| Low Spring | Static Spring Constant (Ks) | 8.6 | 9.1 | 9.2 | 8.3 | 8.0 | 60 |
| Property | Static Spring Constant | 14.3 | 15.2 | 15.3 | 13.8 | 13.3 | 100 |
| | (index) | | | | | | |

*1: Natural rubber “RSS #3”
*2: ISAF, from Asahi Carbon Co., Ltd., trade name “#80” (mean particle size: 22 nm, nitrogen adsorption specific surface area: 115 m²/g, DBP oil absorption (method A): 113 ml/100 g)
*3: Zinc oxide, from Mitsui Mining & Smelting Co., Ltd., zinc oxide class II
*4: 2,2,4-Trimethyl-1,2-dihydroquinoline polymer, from Ouchi Shinko Chemical Industry Co., Ltd., “NOCRAC 224”
*5: N-(1,3-dimethylbutyl)-N′-phenyl-p-phenylenediamine, from Seiko Chemical Co., Ltd., trademark “Ozonone 6C”
*6: Process oil, from Idemitsu Kosan Co., Ltd., Diana Process NH-70S
*7: from Hosoi Chemical Industry Co., Ltd., oil sulfur HK200-5
*8: N-cyclohexyl-2-benzothiazolyl sulfenamide, from Ouchi Shinko Chemical Industry Co., Ltd., “NOCCELER CZ-G”
*9: Di-2-benzothiazolyl disulfide, from Ouchi Shinko Chemical Industry Co., Ltd., “NOCCELER DM-P”

### [Evaluation Results]

Examples 1 to 3 are excellent in durability as compared with Comparative Examples 5 and 6 where the polystyrene-equivalent weight-average molecular weight of the styrene-butadiene rubber (A) used is smaller than 700,000; and Examples 1 to 3 are excellent in durability as compared with Comparative Examples 1 and 3 using oil alone. Further, it is known that Examples 1 to 3 are comparable to Comparative Example 7 using a conventional combination of natural rubber, oil and carbon black in terms of durability, while the former are excellent in point of low spring property as compared with the latter. Example 2 is excellent in durability as compared with Comparative Example 2 in which the styrene-butadiene rubber (B) used has a small vinyl amount. Using more styrene-butadiene rubber (B) than Example 3, Example 1 is excellent in durability while comparable to the latter in terms of low spring property.

### INDUSTRIAL APPLICABILITY

The rubber composition of the present invention can be used for antivibration rubber, more precisely for antivibration rubber for vehicles, even more precisely for torsional dampers, engine mounts, torque rods, upper mounts, strut mounts, bumper stoppers, muffler hangers, inner and outer cylinder bushes, and suspension bushes.

1. An antivibration rubber composition comprising a styrene-butadiene rubber (A) having a polystyrene-equivalent weight-average molecular weight of 700,000 or more, and a liquid styrene-butadiene rubber (B) having a polystyrene-equivalent weight-average molecular weight of 12,000 or less, wherein:
the total amount of the vinyl bond content in the styrene-butadiene rubber (A) and the vinyl bond content in the liquid styrene-butadiene rubber (B) relative to the total amount of the styrene-butadiene rubber (A) and the liquid styrene-butadiene rubber (B) is 25% by mass or more.

2. The antivibration rubber composition according to claim 1, wherein the polystyrene-equivalent weight-average molecular weight of the liquid styrene-butadiene rubber (B) is 5,000 or less.

3. The antivibration rubber composition according to claim 1, wherein the mixing amount of the liquid styrene-butadiene rubber (B) is 10 parts by mass or more relative to 100 parts by mass of the styrene-butadiene rubber (A).

4. The antivibration rubber composition according to claim 1, further comprising a filler which is carbon black having a nitrogen adsorption specific surface area, according to JIS K 6217-2:2001, of 90 to 150 m²/g.

5. The antivibration rubber composition according to claim 4, wherein the mixing amount of the carbon black is 40 parts by mass or less relative to 100 parts by mass of the total amount of a rubber component containing the styrene-butadiene rubber (A) but excluding the liquid styrene-butadiene rubber (B).

6. The antivibration rubber composition according to claim 4, wherein the mixing amount of the carbon black is 1 to 40 parts by mass relative to 100 parts by mass of the total amount of a rubber component containing the styrene-butadiene rubber (A) but excluding the liquid styrene-butadiene rubber (B).

7. An antivibration rubber produced by vulcanizing the antivibration rubber composition of claim 1.

8. The antivibration rubber composition according to claim 2, wherein the mixing amount of the liquid styrene-butadiene rubber (B) is 10 parts by mass or more relative to 100 parts by mass of the styrene-butadiene rubber (A).

9. The antivibration rubber composition according to claim 2, further comprising a filler which is carbon black having a nitrogen adsorption specific surface area, according to JIS K 6217-2:2001, of 90 to 150 m²/g.

10. An antivibration rubber produced by vulcanizing the antivibration rubber composition of claim 2.

11. The antivibration rubber composition according to claim 3, further comprising a filler which is carbon black having a nitrogen adsorption specific surface area, according to JIS K 6217-2:2001, of 90 to 150 m²/g.

12. An antivibration rubber produced by vulcanizing the antivibration rubber composition of claim 3.

13. An antivibration rubber produced by vulcanizing the antivibration rubber composition of claim 4.

14. The antivibration rubber composition according to claim 8, further comprising a filler which is carbon black having a nitrogen adsorption specific surface area, according to JIS K 6217-2:2001, of 90 to 150 m²/g.

15. An antivibration rubber produced by vulcanizing the antivibration rubber composition of claim 8.

16. The antivibration rubber composition according to claim 9, wherein the mixing amount of the carbon black is 40 parts by mass or less relative to 100 parts by mass of the total amount of a rubber component containing the styrene-butadiene rubber (A) but excluding the liquid styrene-butadiene rubber (B).

17. The antivibration rubber composition according to claim 9, wherein the mixing amount of the carbon black is 1 to 40 parts by mass relative to 100 parts by mass of the total amount of a rubber component containing the styrene-butadiene rubber (A) but excluding the liquid styrene-butadiene rubber (B).

18. An antivibration rubber produced by vulcanizing the antivibration rubber composition of claim 9.

19. The antivibration rubber composition according to claim 11, wherein the mixing amount of the carbon black is 40 parts by mass or less relative to 100 parts by mass of the total amount of a rubber component containing the styrene-butadiene rubber (A) but excluding the liquid styrene-butadiene rubber (B).

20. The antivibration rubber composition according to claim 11, wherein the mixing amount of the carbon black is 1 to 40 parts by mass relative to 100 parts by mass of the total amount of a rubber component containing the styrene-butadiene rubber (A) but excluding the liquid styrene-butadiene rubber (B).
